(19) United States
(12) Patent Application Publication
(10) Pub. No.: US 2007/0126401 A1
(43) Pub. Date: Jun. 7, 2007

(54) Power supply system with power storage device

(75) Inventors: Ching-Jou Chen, Taipei City (TW); Kung-Wei Chang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/355,009

(22) Filed: Feb. 16, 2006

(30) Foreign Application Priority Data
Dec. 2, 2005 (TW) 094142442

(51) Int. Cl. H02J 7/00

(52) U.S. Cl. 320/130

(57) ABSTRACT

A power supply system with a power storage device includes an AC-to-DC power supply, a power storage device, a DC-to-DC converter, and a power management device, to construct three different aspects for executing alternating and direct currents in a system.

### BACKGROUND OF THE INVENTION

1. Field of the Invention

The present invention relates to a power supply system and, more particularly, to a power supply system with a power storage device.

2. Description of Related Art

Advances in the electronics industry have led to a phenomenal boom in personal electronic devices such as CD players, MP3 players, PDAs, etc. Power supply devices are becoming more and more important for consumers to conveniently use those electronic devices. The development of the power supply devices including carbon-zinc batteries, mercury batteries, lead acid batteries, lithium ion batteries, lithium-polymer batteries, and fuel cells is focused on high efficiency and a stable power supplying function.

Conventionally, the power supply devices use capacitors for achieving the efficacy of the stored energy. Although energy transformation of the capacitors only occurs on the surfaces of the electrodes thus forming the power density of the capacitor electrodes, the depth of discharging, and the capability of recharging are better than batteries, but the major part of the area of the electrodes of the capacitors is not utilized for energy storage such that the capacity of energy storage of the capacitors is lower than batteries. As a result, when using capacitors to store energy and to obtain the capacity of energy storage of the capacitors as well as the capacity of energy storage of the batteries, the quantity of the necessary capacitors is much greater than the necessary batteries, the volume of the power supply device also increases, and the using of the stored energy is not efficient.

### SUMMARY OF THE INVENTION

The present invention provides a power supply system with a power storage device, including an AC-to-DC power supply, a power storage device, a DC-to-DC converter, and a power management device, to construct three different aspects for executing alternating and direct currents in a system.

In the first aspect of the power supply system of the present invention, the AC-to-DC power supply receives an alternating current of external input and transforms the alternating current into a first direct current, and indicates the existence of the alternating current by using a tag. The power storage device is coupled with the AC-to-DC power supply and includes a battery charger and a rechargeable battery, wherein the battery charger receives the first direct current and generates a charging direct current to electrify the rechargeable battery; the rechargeable battery outputs a second direct current. The DC-to-DC converter is coupled with the AC-to-DC power supply and the rechargeable battery which selects the first direct current or the second direct current as an input power source, and the DC-to-DC converter generates at least one working power source according to the input power source. The power management device is coupled to the DC-to-DC converter to receive the at least one working power source and output at least one output direct current. The power management device is connected to the AC-to-DC power supply, the battery charger, the rechargeable battery, and the DC-to-DC converter by a bus. The power management device detects and controls via the bus the AC-to-DC power supply, the battery charger, the rechargeable battery, and the DC-to-DC converter, wherein the power management device accesses the tag via the bus and transmits a control signal to the DC-to-DC converter to drive the DC-to-DC converter to select the first direct current as the input power source when the tag indicates existence of the alternating current.

In the second aspect of the power supply system of the present invention, the AC-to-DC power supply receives an alternating current of external input and transforms the alternating current into a first direct current and a third direct current, and indicates the existence of the alternating current by using a tag. The power storage device is coupled with the AC-to-DC power supply, and includes a battery charger and a rechargeable battery, wherein the battery charger receives the first direct current and generates a charging direct current to electrify the rechargeable battery; the rechargeable battery outputs a second direct current. The DC-to-DC converter is coupled with the rechargeable battery to receive the second direct current as an input power source, and generates at least one working power source according to the input power source. The power management device is coupled to the DC-to-DC converter and the AC-to-DC power supply that selects the at least one working power source or the third direct current as an input power source, and outputs at least one output direct current. The power management device is connected to the AC-to-DC power supply, the battery charger, the rechargeable battery, and the DC-to-DC converter by a bus. The power management device detects and controls via the bus the AC-to-DC power supply, the battery charger, the rechargeable battery, and the DC-to-DC converter, wherein the power management device accesses the tag via the bus and selects the third direct current as the input power source when the tag indicates existence of the alternating current.

In the third aspect of the power supply system of the present invention, the AC-to-DC power supply receives an alternating current of external input and transforms the alternating current into a first direct current, and indicates the existence of the alternating current by using a tag. The power storage device is coupled with the AC-to-DC power supply, and includes a battery charger and a rechargeable battery, wherein the battery charger receives the first direct current and generates a charging direct current to electrify the rechargeable battery; the rechargeable battery outputs a second direct current. The DC-to-DC converter is coupled with the AC-to-DC power supply and the rechargeable battery that selects the first direct current or the second direct current as an input power source, and generates at least one working power source to be an output direct current according to the input power source. The power management device is connected to the AC-to-DC power supply, the battery charger, the rechargeable battery, and the DC-to-DC converter by a bus. The power management device detects and controls the AC-to-DC power supply, the battery charger, the rechargeable battery, and the DC-to-DC converter by the bus, wherein the power management device accesses the tag via the bus and transmits a control signal to the DC-to-DC converter to drive the DC-to-DC converter to select the first direct current as the input power source when the tag indicates existence of the alternating current.

The present invention provides three aspects of the power supply system with the power storage device. When an external power source stops supplying power or is unstable, the power storage device is capable of continuously to supplying power to prevent interruption of the operation of a machine.

Other objects, advantages, and novel features of the invention will become more apparent from the following detailed description when taken in conjunction with the accompanying drawings.

### BRIEF DESCRIPTION OF THE DRAWINGS

FIG. 1 shows a power supply system of the first embodiment of the present invention;

FIG. 2 shows a power supply system of the second embodiment of the present invention;

FIG. 3 shows a power supply system of the third embodiment of the present invention.

### DETAILED DESCRIPTION OF THE PREFERRED EMBODIMENT

The power supply system of the present invention includes an AC-to-DC power supply, a power storage device, a DC-to-DC converter, and a power management device, to construct three different aspects for executing alternating and direct currents in a system.

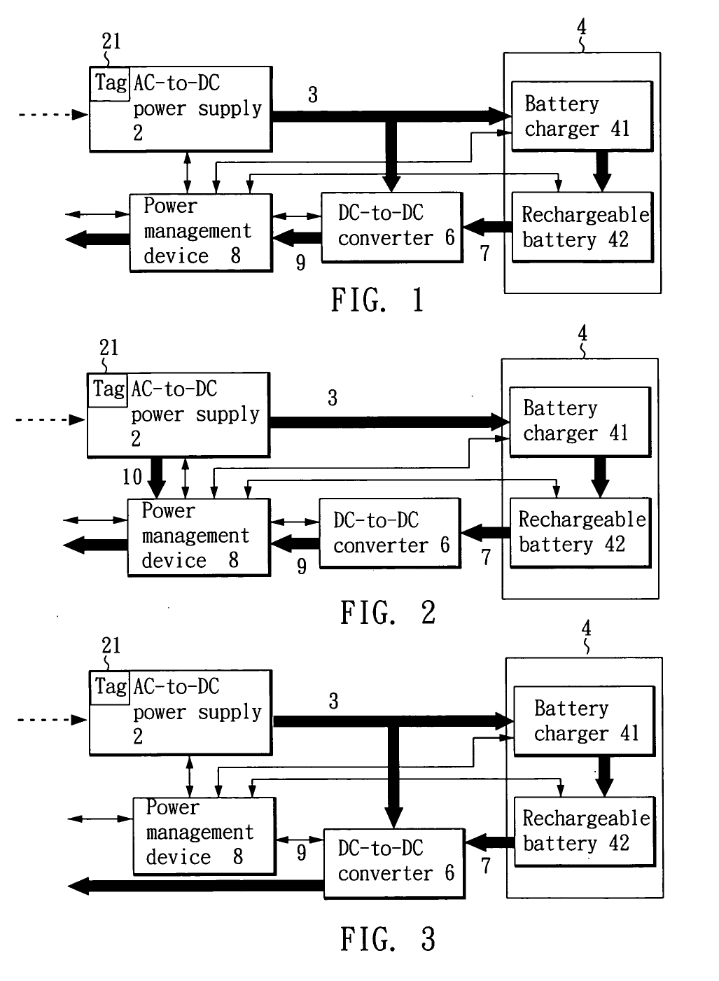

FIG. 1 shows a power supply system of the first embodiment of the present invention, wherein a power management device 8 is connected to an AC-to-DC power supply 2, a battery charger 41, a rechargeable battery 42, and a DC-to-DC converter 6 by a bus of I²C. The power management device 8 detects and controls via the bus multiple conditions of the AC-to-DC power supply 2, a battery charger 41, the rechargeable battery 42, and the DC-to-DC converter 6, such as temperature, voltage, current, and the recharging status of a power storage device 4. The power storage device 4 is coupled with the AC-to-DC power supply 2 and includes the battery charger 41 and the rechargeable battery 42. The DC-to-DC converter 6 is coupled with the AC-to-DC power supply 2 and the rechargeable battery 42. The power management device 8 is coupled with the DC-to-DC converter 6.

When the AC-to-DC power supply 2 receives an alternating current from an external input power source, the alternating current is transformed into a first direct current 3, and a tag 21 to indicate the existence of the alternating current labels the first direct current 3.

Thus, when the tag 21 indicates the existence of the alternating current, the first direct current 3 inputs into the power storage device 4 for recharging and inputs into the DC-to-DC converter 6 for outputting. The battery charger 41 of the power storage device 4 receives the first direct current 3 and generates a charging direct current 5 to electrify the rechargeable battery 42, and the rechargeable battery 42 outputs a second direct current 7 into the DC-to-DC converter 6.

When the power management device 8 accesses the tag 21 via the bus and confirms the existence of the alternating current, the power management device 8 transmits a control signal to the DC-to-DC converter 6 to drive the DC-to-DC converter 6 to select the first direct current 3 as the input power source rather than the second direct current 7. After the DC-to-DC converter 6 receives the first direct current 3, the DC-to-DC converter 6 adjusts the first direct current 3 to generate a working power source 9. The voltage of the working power source 9 may be +24V, −24V, +12V, −12V, +9V, −9V, +5V, −5V, +3.3V, −3.3V, or +2.5V. The power management device 8 outputs the working power source 9.

On the other hand, when the power management device 8 accesses the tag 21 via the bus and detects that the alternating current does not exist or is unstable, the rechargeable battery 42 of the power storage device 4 outputs a second direct current 7 into the DC-to-DC converter 6. The DC-to-DC converter 6 adjusts the first direct current 3 to generate a working power source 9. The voltage of the working power source 9 may be +24V, −24V, +12V, −12V, +9V, −9V, +5V, −5V, +3.3V, −3.3V, or +2.5V.

Similarly, FIG. 2 shows a power supply system of the second embodiment of the present invention, wherein a power management device 8 is connected to an AC-to-DC power supply 2, a battery charger 41, a rechargeable battery 42, and a DC-to-DC converter 6 by a bus of I²C. The AC-to-DC power supply 2 is coupled with the battery charger 41 of the power storage device 4 and the power management device 8. The DC-to-DC converter 6 couples the rechargeable battery 42 of the power storage device 4 with the power management device 8.

When the AC-to-DC power supply 2 receives an alternating current from an external input power source, the alternating current is transformed into a first direct current 3 and a third direct current 10, and a tag 21 is utilized to indicate the existence of the alternating current.

When the tag 21 indicates the existence of the alternating current, the first direct current 3 inputs into the power storage device 4 for recharging, and the third current 10 inputs into the power management device 8. The battery charger 41 of the power storage device 4 receives the first direct current 3 and generates a charging direct current 5 to electrify the rechargeable battery 42, and the rechargeable battery 42 outputs a second direct current 7 to the DC-to-DC converter 6. The DC-to-DC converter 6 adjusts the second direct current 7 to generate a working power source 9 and the second direct current 7 inputs into the power management device 8. The voltage of the working power source 9 may be +24V, −24V, +12V, −12V, +9V, −9V, +5V, −5V, +3.3V, −3.3V, or +2.5V.

When the power management device 8 accesses the tag 21 via the bus and confirms the existence of the alternating current, the power management device 8 selects the third direct current 10 as the input power source rather than the working power source 9. The power management device 8 adjusts the third direct current 10 to output power source. The voltage of the third direct current 10 may be +24V, −24V, +12V, −12V, +9V, −9V, +5V, −5V, +3.3V, −3.3V, or +2.5V.

On the other hand, when the power management device 8 accesses the tag 21 via the bus and detects that the alternating current does not exist or is unstable, the rechargeable battery 42 of the power storage device 4 outputs a second direct current 7 into the DC-to-DC converter 6. The DC-to-DC converter 6 adjusts the first direct current 3 to generate a working power source 9. The power management device 8 outputs the working power source 9. The voltage of the working power source 9 may be +24V, −24V, +12V, −12V, +9V, −9V, +5V, −5V, +3.3V, −3.3V, or +2.5V.

FIG. 3 shows a power supply system of the third embodiment of the present invention, wherein a power management device 8 is connected to an AC-to-DC power supply 2, a battery charger 41, a rechargeable battery 42, and a DC-to-DC converter 6 by a bus of I²C. The AC-to-DC power supply 2 is coupled with the battery charger 41 of a power storage device 4 and the DC-to-DC converter 6. The battery charger 41 of a power storage device 4 is coupled with the DC-to-DC converter 6 by the rechargeable battery 42.

When the AC-to-DC power supply 2 receives an alternating current from an external input power source, the alternating current is transformed into a first direct current 3, and a tag 21 is utilized to indicate the existence of the alternating current.

Thus, when the tag 21 indicates the existence of the alternating current, the first direct current 3 inputs into the power storage device 4 for recharging, and inputs into the DC-to-DC converter 6 for outputting. The battery charger 41 of the power storage device 4 receives the first direct current 3 and generates a charging direct current 5 to electrify the rechargeable battery 42, and the rechargeable battery 42 outputs a second direct current 7 into the DC-to-DC converter 6.

When the power management device 8 accesses the tag 21 via the bus and confirms the existence of the alternating current, the power management device 8 transmits a control signal to the DC-to-DC converter 6 to drive the DC-to-DC converter 6 to select the first direct current 3 as the input power source rather than the second direct current 7. After the DC-to-DC converter 6 receives the first direct current 3, the DC-to-DC converter 6 adjusts the first direct current 3 to generate a working power source 9. The working power source is the output power source directly and not by the power management device 8. The voltage of the working powers source 9 may be +24V, −24V, +12V, −12V, +9V, −9V, +5V, −5V, +3.3V, −3.3V, or +2.5V. The power management device 8 outputs the working power source 9.

On the other hand, when the power management device 8 accesses the tag 21 via the bus and detects that the alternating current does not exist or is unstable, the rechargeable battery 42 of the power storage device 4 outputs a second direct current 7 into the DC-to-DC converter 6. The DC-to-DC converter 6 adjusts the first direct current 3 to generate a working power source 9. The voltage of the working powers source 9 may be +24V, −24V, +12V, −12V, +9V, −9V, +5V, −5V, +3.3V, −3.3V, or +2.5V.

As described above, by means of an alternating current inputted by an external input device, the power supply system of the invention is capable of maintaining an operational of a machine normally. The power storage device may be a lithium ion battery, lithium-polymer battery or, fuel cell, wherein the inner condition such as temperature, voltage, current, and the moisture content and fuel material in the fuel cell of the lithium ion battery and lithium-polymer battery and fuel cell can be controlled by the power management device 8. As a result, the present invention uses batteries to enhance the intensity and efficient of the power supply system.

Although the present invention has been explained in relation to its preferred embodiment, it is to be understood that many other possible modifications and variations can be made without departing from the scope of the invention as hereinafter claimed.

What is claimed is:

1. A power supply system with a power storage device, comprising:
an AC-to-DC power supply receiving an alternating current of external input, transforming the alternating current into a first direct current, and indicating the existence of the alternating current by using a tag;
a power storage device coupled with the AC-to-DC power supply, and including a battery charger and a rechargeable battery, wherein the battery charger receives the first direct current and generates a charging direct current to electrify the rechargeable battery, the rechargeable battery outputs a second direct current;
a DC-to-DC converter coupled with the AC-to-DC power supply and the rechargeable battery which selects the first direct current or the second direct current as an input power source, and generates at least one working power source according to the input power source; and
a power management device coupled to the DC-to-DC converter to receive the at least one working power source and output at least one output direct current, connected to the AC-to-DC power supply, the battery charger, the rechargeable battery, and the DC-to-DC converter by a bus, wherein the power management device detects and controls the AC-to-DC power supply, the battery charger, the rechargeable battery, and the DC-to-DC converter by the bus;
wherein the power management device accesses the tag via the bus and transmits a control signal to the DC-to-DC converter to drive the DC-to-DC converter to select the first direct current as the input power source when the tag indicates existence of the alternating current.

2. The power supply system of claim 1, wherein the rechargeable battery is a fuel cell.

3. The power supply system of claim 1, wherein the rechargeable battery is a lithium ion battery.

4. The power supply system of claim 1, wherein the rechargeable battery is a lithium-polymer battery.

5. The power supply system of claim 1, wherein the power management device detects and controls the temperatures of the AC-to-DC power supply, the battery charger, the rechargeable battery, and the DC-to-DC converter by the bus.

6. The power supply system of claim 1, wherein the power management device detects and controls the voltages of the AC-to-DC power supply, the battery charger, the rechargeable battery, and the DC-to-DC converter by the bus.

7. The power supply system of claim 1, wherein the power management device detects and controls the currents of the AC-to-DC power supply, the battery charger, the rechargeable battery, and the DC-to-DC converter by the bus.

8. The power supply system of claim 2, wherein the power management device detects and controls the moisture and the fuel of the fuel cell by the bus.

9. The power supply system of claim 1, wherein the bus is an I²C bus.

10. The power supply system of claim 1, wherein the voltage of the at least one working power source is selected from a group consisting of +24V, −24V, +12V, −12V, +9V, −9V, +5V, −5V, +3.3V, −3.3V, and +2.5V.

11. A power supply system with a power storage device, comprising:
an AC-to-DC power supply receiving an alternating current of external input, transforming the alternating current into a first direct current and a third direct current, and indicating the existence of the alternating current by using a tag;
a power storage device coupled with the AC-to-DC power supply, and including a battery charger and a rechargeable battery, wherein the battery charger receives the first direct current and generates a charging direct current to electrify the rechargeable battery, and the rechargeable battery outputs a second direct current;
a DC-to-DC converter coupled with the rechargeable battery to receive the second direct current as an input power source, and generating at least one working power source according to the input power source; and
a power management device coupled to the DC-to-DC converter and the AC-to-DC power supply which select the at least one working power source or the third direct current as an input power source, and output at least one output direct current, the power management device connected to the AC-to-DC power supply, the battery charger, the rechargeable battery, and the DC-to-DC converter by a bus, wherein the power management device detects and controls the AC-to-DC power supply, the battery charger, the rechargeable battery, and the DC-to-DC converter by the bus;
wherein the power management device accesses the tag via the bus and selects the third direct current as the input power source when the tag indicates existence of the alternating current.

12. The power supply system of claim 11, wherein the rechargeable battery is a fuel cell.

13. The power supply system of claim 11, wherein the rechargeable battery is a lithium ion battery.

14. The power supply system of claim 1, wherein the rechargeable battery is a lithium-polymer battery.

15. The power supply system of claim 11, wherein the power management device detects and controls the temperatures of the AC-to-DC power supply, the battery charger, the rechargeable battery, and the DC-to-DC converter by the bus.

16. The power supply system of claim 11, wherein the power management device detects and controls the voltages of the AC-to-DC power supply, the battery charger, the rechargeable battery, and the DC-to-DC converter by the bus.

17. The power supply system of claim 11, wherein the power management device detects and controls the currents of the AC-to-DC power supply, the battery charger, the rechargeable battery, and the DC-to-DC converter by the bus.

18. The power supply system of claim 12, wherein the power management device detects and controls the moisture and the fuel of the fuel cell by the bus.

19. The power supply system of claim 11, wherein the bus is an I²C bus.

20. The power supply system of claim 11, wherein the voltage of the at least one working power source is selected from a group consisting of the +24V, −24V, +12V, −12V, +9V, −9V, +5V, −5V, +3.3V, −3.3V, and +2.5V.

21. A power supply system with a power storage device, comprising:
an AC-to-DC power supply receiving an alternating current of external input, transforming the alternating current into a first direct current, and indicating the existence of the alternating current by using a tag;
a power storage device coupled with the AC-to-DC power supply, and including a battery charger and a rechargeable battery, wherein the battery charger receives the first direct current and generates a charging direct current to electrify the rechargeable battery, and the rechargeable battery outputs a second direct current;
a DC-to-DC converter coupled with the AC-to-DC power supply and the rechargeable battery which selects the first direct current or the second direct current as an input power source, and generates at least one working power source to be an output direct current according to the input power source; and
a power management device connected to the AC-to-DC power supply, the battery charger, the rechargeable battery, and the DC-to-DC converter by a bus, wherein the power management device detects and controls the AC-to-DC power supply, the battery charger, the rechargeable battery, and the DC-to-DC converter by the bus;
wherein the power management device accesses the tag via the bus and transmits a control signal to the DC-to-DC converter to drive the DC-to-DC converter to select the first direct current as the input power source when the tag indicates existence of the alternating current.

22. The power supply system of claim 21, wherein the rechargeable battery is a fuel cell.

23. The power supply system of claim 21, wherein the rechargeable battery is a lithium ion battery.

24. The power supply system of claim 21, wherein the rechargeable battery is a lithium-polymer battery.

25. The power supply system of claim 21, wherein the power management device detects and controls the temperatures of the AC-to-DC power supply, the battery charger, the rechargeable battery, and the DC-to-DC converter by the bus.

26. The power supply system of claim 21, wherein the power management device detects and controls the voltages of the AC-to-DC power supply, the battery charger, the rechargeable battery, and the DC-to-DC converter by the bus.

27. The power supply system of claim 21, wherein the power management device detects and controls the currents of the AC-to-DC power supply, the battery charger, the rechargeable battery, and the DC-to-DC converter by the bus.

28. The power supply system of claim 22, wherein the power management device detects and controls the moisture and the fuel of the fuel cell by the bus.

29. The power supply system of claim 21, wherein the bus is an I²C bus.

30. The power supply system of claim 21, wherein the voltage of the at least one working power source is selected from a group consisting of the +24V, −24V, +12V, −12V, +9V, −9V, +5V, −5V, +3.3V, −3.3V, and +2.5V.
